(19) United States
(12) Patent Application Publication
(10) Pub. No.: US 2006/0151553 A1
(43) Pub. Date: Jul. 13, 2006

(54) Corporate cargo rack

(75) Inventors: Craig A. Stapleton, St. Clair, MI (US); Carl Jones, Kimball, MI (US); Jeffrey J. Meikle, Utica, MI (US); Larry Pavlik, Sterling Heights, MI (US); Duane Walsh, Columbus, MI (US); Hugh Howson, Aurora (CA)

Correspondence Address: WARN, HOFFMANN, MILLER & LALONE, .P.C, PO BOX 70098, ROCHESTER HILLS, MI, 48307, US

(73) Assignees: Magna International Inc., Aurora (CA); Decoma International Inc.

(21) Appl. No.: 11/302,022

(22) Filed: Dec. 13, 2005

Related U.S. Application Data
(60) Provisional application No. 60/635,782, filed on Dec. 14, 2004.

(51) Int. Cl. B60R 9/00; B60R 9/058

(52) U.S. Cl. 224/326; 224/329

(57) ABSTRACT

Cargo rack systems are described. The systems include side rails that are easily attached to support members mounted on a vehicle's roof portion. The side rails include an opening such as a channel portion formed on a top surface thereof. One or more fastening members are then employed to secure the side rails to the stanchions. The cross rails are easily attached to the side rails in any number of configurations. The cross rails are fastened to a stanchion with one or more fastening members, wherein the stanchion fits over the cross rail, with the stanchion being fastened to the side rail with a clamp member that is fastened to the stanchion by one or more fastening members. In this manner, any number of different combinations and different types of cargo rack systems may be easily attached to the vehicle's roof portion.

### CROSS-REFERENCE TO RELATED APPLICATION

The instant application claims priority to U.S. Provisional Patent Application Ser. No. 60/635,782, filed Dec. 14, 2004, the entire specification of which is expressly incorporated herein by reference.

### FIELD OF THE INVENTION

The present invention relates generally to cargo racks for motor vehicles. More specifically, the present invention relates to cargo rack systems for a motor vehicle including easily assembled and/or disassembled side rail and cross rail members corresponding to various vehicle brands, vehicle brand models, and trim packages.

### BACKGROUND OF THE INVENTION

Cargo racks for motor vehicles are generally well known in the art. Many vehicles have cargo racks comprising frames and/or rails on their exterior surfaces, such as their roof, on which luggage or other cargo can be placed for transport. Typically, such cargo racks include strips or rails on which the cargo is placed to prevent the cargo from directly contacting the vehicle surface to prevent damage thereto and/or to spread the load of the cargo over a larger area of the vehicle surface to prevent deformation of vehicle body panels. Further, cargo racks typically provide some mechanism, such as surrounding rails, tie downs and/or enclosures to prevent undesired movement of the cargo on the surface and to keep the cargo on the cargo rack while the vehicle moves.

Conventional factory installed roof racks, with adjustable cross rails, are typically designed and developed anew. That is, all the new components, such as the side and cross rail sections, cross rail mechanisms for attaching to the side rails, supports (e.g., stanchions), and the like, are designed every time a new roof rack is needed, e.g., for a new vehicle brand, a new vehicle brand model, or a particular trim package.

As a result of the new design requirements, the consumer is thus faced with several different potential types of new cross rail latching and unlatching mechanisms, e.g., for every vehicle brand, vehicle brand model, and/or trim package. One typical complaint from consumers is the apparent confusion as to how the cross rail mechanisms are supposed to operate. The likely cause of this confusion is that the operation of the current mechanisms is not readily obvious, as some mechanisms are the push button type, slide button type, pull lever type, push lever type, or the like.

Accordingly, there exists a need for new and improved cargo rack systems that are simple and inexpensive to manufacture, easily operated (e.g., assembled and/or disassembled) by consumers, and aesthetically pleasing.

### SUMMARY OF THE INVENTION

It is an object of the present invention to provide a new and improved cargo rack system for motor vehicles which obviates at least one disadvantage of the prior art.

It is an object of the present invention to provide a new, simple, low cost, structural cargo rack system based on the industries best practices for structure, aerodynamics, material, finish, processing, mechanisms, and the like.

It is an object of the present invention to provide a side rail section that will be designed to be used as a raised or flush mount application and to be exposed so that the rail can have different finishes that are visible for each vehicle trim level if a distinctive look is required.

It is an object of the present invention to provide a side rail section will be a carry over structural component for all of the automaker's vehicle lines, wherein the section will be used on all new cargo rack systems.

It is an object of the present invention to provide a cross rail section that will be designed to the industries best practices to eliminate wind noise and to have the required structure.

It is an object of the present invention to provide a cross rail section that will be designed so that the rail can have different finishes for each vehicle trim level if a distinctive look is required.

It is an object of the present invention to provide a cross rail section that will be a carry over structural component for all of the automakers vehicle lines, wherein the section will be used on all new cargo rack systems.

It is an object of the present invention to provide cross rail systems that are easily adjustable and removable.

It is an object of the present invention to provide a cross rail mechanism design that is simple, structural, and based on the industries best practices, wherein the mechanism will be a carry over system for all of the automaker's vehicle lines.

It is an object of the present invention to provide attachment components to the vehicle that varies in styling and finish to give the rack a unique look from one vehicle to another.

The present invention preferably reduces the time required to develop and tool a new rack system. For example, the only new components to design and engineer are the attachment components to the vehicle roof panel.

The present invention preferably utilizes carry over, proven structural, aerodynamic and mechanical components. For example, this eliminates the concerns for validation and problems that can occur at launch of the new product.

The present invention, by using carry over sections and mechanisms, will preferably improve the production efficiency of the rack manufacturer. For example, this will lower cost of the product and tooling is reduced due to only a few new components (e.g., attachment components) are required to engineer, design and tool.

The present invention, by using carry over simplified cross rail mechanism for all models and makes, will preferably reduce any confusion by the end user on how the mechanism operates is reduced.

The present invention, by changing finishes and the styling of the attachment components, will preferably enable a distinct rack appearance that can be achieved for different trim levels and car lines.

The present invention preferably takes into full consideration the industry best practices for structure, aerodynamics, material, finish, processing, mechanisms, and the like that were derived from the best of the current practices in the industry.

In accordance with the general teachings of the present invention, new and improved cargo rack systems are provided. In accordance with one aspect of the present invention, the cargo rack systems are simple and inexpensive to manufacture, easily operated (e.g., assembled and/or disassembled) by consumers, and aesthetically pleasing.

Specifically, the cargo rack systems include one or more side rails that are easily attached to support members mounted on the vehicle's roof portion. The support members can be configured in any number of shapes, and can include more than one portion (e.g., a front portion and a discontinuous rear portion). Furthermore, the support members can include integrated or discrete support portions (e.g., for supporting the side rails).

In accordance With one aspect of the present invention, the side rails include an opening such as a channel portion or a bore formed on a top and/or bottom surface thereof. One or more fastening members (e.g., screws) are then employed to secure the side rails to the support members in a manner wherein the fastening members are substantially obscured from view once installation has taken place. The side rails can either be flush against the stanchions, flush against the roof portion of the vehicle, raised above the roof portion of the vehicle, raised above the stanchions, or any combination thereof.

In accordance with one aspect of the present invention, the cross rails are easily attached to the side rails in any number of configurations. The cross rails are fastened to a stanchion assembly with one or more fastening members (e.g., screws), wherein the stanchion assembly fits over the cross rail, with the stanchion assembly being fastened to the side rail with a clamp member that is fastened to the stanchion assembly by one or more fastening members (e.g., screws). In this manner, any number of different combinations and different types of cargo rack systems may be easily attached to the vehicle's roof portion.

More specifically, the side rail includes an open section having a substantially T-shaped slot formed on the top surface thereof. The undersurface of the T-shaped slot includes a spline knurl that interlocks with the stanchion lock plate to prevent the cross rail from shifting, e.g., when loaded and a panic stop occurs. The section of the side rail is structural so that it can be used as either a flush mount (e.g., directly abutting the roof surface) or as a raised side rail (e.g., suspended above the roof surface, i.e., supported only at the ends and center portions). The side rail section is designed to be an exposed rail such that finish changes can alter the appearance thereof. In accordance with one aspect of the present invention, front, rear and center supports close off the ends and support the side rail. The supports add a styling feature to the assembly and they can have molded in features such as but not limited to tie loops. The supports are attached to each end of the side rail with molded in snaps.

In accordance with one aspect of the present invention, the attachment system to the vehicle is hidden down inside the side rail. Access is through the T-shaped slot at the top of the side rail. This eliminates the need for additional components such as but not limited to covers or caps to hide the attachment system (although covers and caps can be used for aesthetic and other purposes as well). There are no fasteners required to assemble the side rail assemblies, and no gaskets are required for the supports.

In accordance with one aspect of the present invention, the cross rail is an aerodynamic, structural load bearing section. The section eliminates potential wind noise (e.g., with texture, paint, trip beads, elliptical contours, and the like). The cross rail is mechanically fastened to the stanchion assembly.

In accordance with one aspect of the present invention, the stanchion assembly includes the stanchion, clamping screw (e.g., a thumbwheel), and clamp subassembly. The stanchion assembly clamps over the side rail design for easy installation and removal. In accordance with one aspect of the present invention, the clamp subassembly includes a clamp, nut and anti-skid pad. The clamp subassembly securely holds the stanchion in a desired location along the length of the side rail. The clamp, in conjunction with the clamping screw and the nut, provides the compression force to sandwich the side rail between the clamp and the bottom surface of the stanchion assembly. The anti-skid pad provides the required resistance to slip of the cross rail along the length of the side rail, e.g., when loaded and a panic stop occurs. The nut is a threaded fastener that is post installed into the clamp and serves as the threaded counterpart of the clamping screw. The clamping screw, as mentioned above in conjunction with the nut and the clamp, provides the required compression force to secure the cross rail in a desired location along the length of the side rail. The stanchion assembly provides the housing for the clamping mechanism (e.g., clamp subassembly and clamping screw). The stanchion assembly also provides the required structural connection of the cross rail to the side rail. The stanchion assembly adds aesthetic appeal to the system and it includes integrated functional features such as but not limited to tie loops.

In accordance with a first embodiment of the present invention, a cargo rack system is provided, comprising: (1) a support system fastened to a roof portion of a vehicle, the support system having a receptacle formed therein operable to receive a fastening member; (2) a side rail member having a bore formed in a surface thereof; and (3) a fastening member operable to fasten a portion of the side rail member to a portion of the support system, wherein the fastening member is substantially recessed into the receptacle when the side rail member is fastened to the support system so as to substantially obscure the fastening member from view.

In accordance with a second embodiment of the present invention, a cargo rack system is provided, comprising: (1) a support system fastened to a roof portion of a vehicle, the support system having a receptacle formed therein operable to receive a fastening member; (2) a side rail member; (3) a first fastening member operable to fasten a portion of the side rail member to a portion of the support system; (4) a cross rail member; and (5) a stanchion assembly operable to fasten a portion of the cross rail member to the side rail member.

In accordance with a third embodiment of the present invention, a cargo rack system is provided, a cargo rack system is provided, comprising: (1) a support system fastened to a roof portion of a vehicle, the support system having a receptacle formed therein operable to receive a fastening member; (2) a side rail member; (3) a first fastening member operable to fasten a portion of the side rail member to a portion of the support system; (4) a cross rail member; and (5) a stanchion assembly operable to fasten a portion of the cross rail member to the side rail member, wherein the stanchion assembly includes a stanchion member, a clamp member, and a second fastening member, wherein the stanchion member and the clamp member are operable to envelope a portion of the side rail member, wherein the second fastening member fastens the second stanchion member and the clamp member together when the second stanchion member and the clamp member envelope a portion of the side rail member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial perspective view of a side rail system fastened to the roof portion of a vehicle, in accordance with a first embodiment of the present invention;

FIG. 2 is a partial perspective view of a front support for a side rail member, in accordance with a second embodiment of the present invention;

FIG. 3 is a partial perspective view of a first alternative front support for a side rail member, in accordance with a third embodiment of the present invention;

FIG. 4 is a partial perspective view of a second alternative front support for a side rail member, in accordance with a fourth embodiment of the present invention;

FIG. 5 is a partial perspective view of a first alternative side rail system fastened to the roof portion of a vehicle, in accordance with a fifth embodiment of the present invention;

FIG. 6 is a partial perspective view of a second alternative side rail system fastened to the roof portion of a vehicle, in accordance with a sixth embodiment of the present invention;

FIG. 7 is a partial perspective view of a third alternative side rail system fastened to the roof portion of a vehicle, in accordance with a seventh embodiment of the present invention;

FIG. 8 is a partial perspective view of a fourth alternative side rail system fastened to the roof portion of a vehicle, in accordance with an eighth embodiment of the present invention;

FIG. 9 is a partial perspective view of a fifth alternative side rail system, in accordance with a ninth embodiment of the present invention;

FIG. 10 is a partial exploded view of the fifth alternative side rail system depicted in FIG. 9, in accordance with a ninth embodiment of the present invention;

FIG. 11 is a partial perspective view of the fifth alternative side rail system along line 11-11 of FIG. 10, in accordance with a ninth embodiment of the present invention;

FIG. 12 is a partial perspective view of a cargo rack system fastened to the roof portion of a vehicle, in accordance with a tenth embodiment of the present invention;

FIG. 13 is a partial side elevational view of the cargo rack system depicted in FIG. 12, in accordance with a tenth embodiment of the present invention;

FIG. 14 is a partial rear elevational view of the cargo rack system depicted in FIG. 12, in accordance with a tenth embodiment of the present invention;

FIG. 15 is a partial perspective view of a stanchion assembly of the cargo rack system depicted in FIG. 12, in accordance with a tenth embodiment of the present invention;

FIG. 16 is a perspective view of an alternative cargo rack system fastened to the roof portion of a vehicle, in accordance with an eleventh embodiment of the present invention;

FIG. 17 is a plan view of the alternative cargo rack system depicted in FIG. 16, in accordance with an eleventh embodiment of the present invention;

FIG. 18 is an exploded view of the alternative cargo rack system depicted in FIG. 16, in accordance with an eleventh embodiment of the present invention;

FIG. 19 is a sectional view of a cross rail member, in accordance with a twelfth embodiment of the present invention;

FIG. 20 is a sectional view of a first alternative side rail member, in accordance with a thirteenth embodiment of the present invention;

FIG. 21 is a sectional view of a second alternative side rail member, in accordance with a fourteenth embodiment of the present invention;

FIG. 22 is a partial sectional view of a cross rail stanchion assembly, in accordance with a fifteenth embodiment of the present invention;

FIG. 23 is a partial exploded view of the cross rail stanchion assembly depicted in FIG. 22, in accordance with a fifteenth embodiment of the present invention; and

FIG. 24 is another partial exploded view of the cross rail stanchion assembly depicted in FIG. 22, in accordance with a fifteenth embodiment of the present invention.

### DETAILED DESCRIPTION OF THE INVENTION

The following description of the preferred embodiment(s) is merely exemplary in nature and is in no way intended to limit the invention, its application, or uses.

The present invention is preferably intended to allow the cargo rack systems and components thereof, to be incorporated onto any vehicle, regardless of manufacturer, brand, model, or trim level. Furthermore, it is intended that the present invention become the industry standard for the manufacture, installation, and/or modification of cargo rack systems and components thereof.

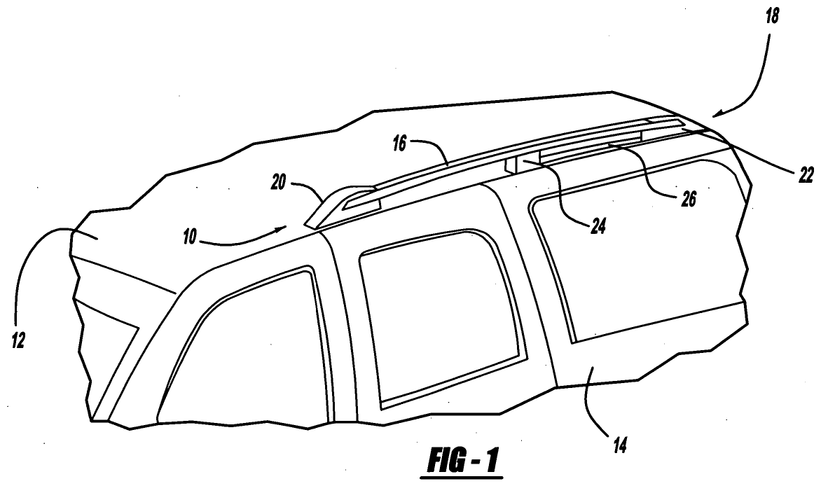

Referring to FIG. 1, there is shown a partial perspective view of a side rail system 10 fastened to the roof portion 12 of a vehicle 14, in accordance with a first embodiment of the present invention. The side rail system 10 primarily includes a side rail member 16 fastened to a support system 18, which can include a front support member 20 and a rear support member 22. In this view, the front support member 20 envelopes an end portion of the side rail member 16, the rear support member 22 envelopes the other end portion of the side rail member 16, and a center support member 24 (extending from the rear support member 22) supports a bottom surface of the side rail member 16. A gap 26 is formed underneath the bottom rear surface of the side rail member 16, e.g., between the center support member 24 and the rear support member 22. It should be appreciated that the front, center and/or rear support members can be configured in any number of shapes, as will be described herein.

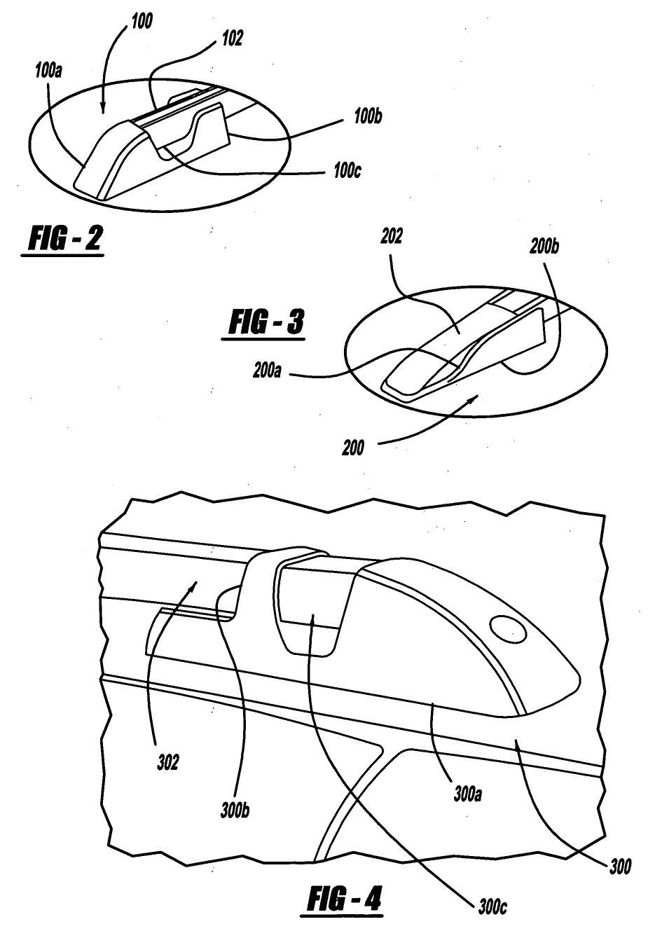

Referring to FIG. 2, there is shown a partial perspective view of a front support member 100 for a side rail member 102, in accordance with a second embodiment of the present invention. In this view, a first portion 100a of the front support member 100 envelopes an end portion of the side rail member 102 and a second portion 100b cradles another portion of the side rail member 102. In accordance with one aspect of the present invention, the first portion 100a quickly slopes downwardly toward the roof portion of the vehicle. In accordance with another aspect of the present invention, the second portion 100b includes a blunt portion that extends downwardly towards the roof portion of the vehicle. Situated between portions 100a and 100b is an area defining a notch 100c. It should be appreciated that the front support member 100 can also be used in conjunction with a rear support member as well.

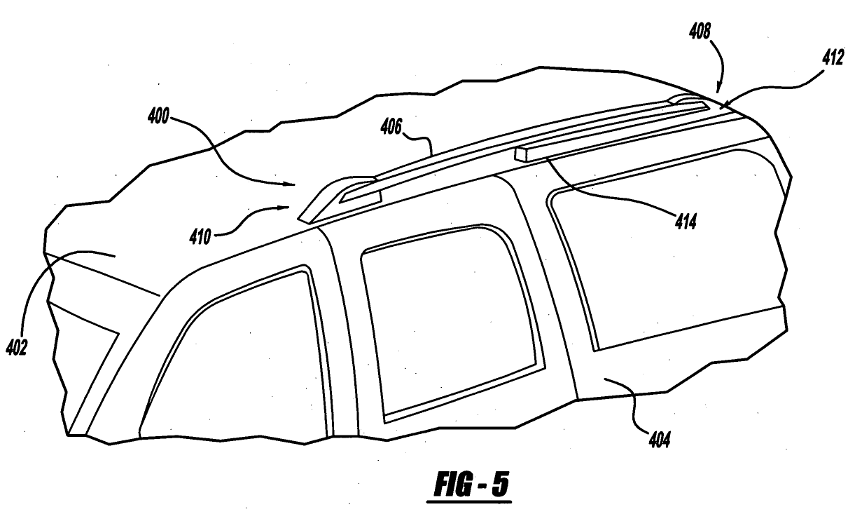

Referring to FIG. 3, there is shown a partial perspective view of a first alternative front support 200 for a side rail member 202, in accordance with a third embodiment of the present invention. In accordance with one aspect of the present invention, a first portion 200a of the front support member 200 cradles an end portion of the side rail member 202 (thus exposing the top surface of the side rail member 202) and gradually slopes downwardly toward the roof portion of the vehicle. In accordance with another aspect of the present invention, a second portion 200b of the front support member 200 includes a blunt portion that extends downwardly towards the roof portion of the vehicle. It should be appreciated that the front support member 200 can also be used in conjunction with a rear support member as well.

Referring to FIG. 4, there is shown a partial perspective view of a second alternative front support 300 for a side rail member 302, in accordance with a fourth embodiment of the present invention. In this view, a first portion 300a of the front support member 300 envelopes an end portion of the side rail member 302 and a second portion 300b envelopes another portion of the side rail member 302. In accordance with one aspect of the present invention, the first portion 300a quickly slopes downwardly toward the roof portion of the vehicle. In accordance with another aspect of the present invention, the second portion 300b includes a C-shaped portion that extends over the top surface of the side rail member 302. Situated between portions 300a and 300b is an area defining a notch 300c. It should be appreciated that the front support member 300 can also be used in conjunction with a rear support member as well.

Referring to FIG. 5, there is shown a partial perspective view of a first alternative side rail system 400 fastened to the roof portion 402 of a vehicle 404, in accordance with a fifth embodiment of the present invention. The side rail system 400 primarily includes a side rail member 406 fastened to a support system 408, which can include a front support member 410 and a rear support member 412. In this view, the front support member 410 envelopes an end portion of the side rail member 406, the rear support member 412 envelopes the other end portion of the side rail member 406, and a center support member 414 (extending from the rear support member 412) supports a bottom surface of the side rail member 406. The center support member 414 abuts directly against the bottom rear surface of the side rail member 406, as opposed to leaving a gap therebetween as shown in FIG. 1.

Referring to FIG. 6, there is shown a partial perspective view of a second alternative side rail system 500 fastened to the roof portion 502 of a vehicle 504, in accordance with a sixth embodiment of the present invention. The side rail system 500 primarily includes a side rail member 506 fastened to a support system 508, which can include a front support member 510, a center support member 512, and a rear support member 514. In this view, the front support member 510 envelopes an end portion of the side rail member 506, the rear support member 514 envelopes the other end portion of the side rail member 506, and the center support member 512 supports a bottom surface of the side rail member 506. The center support member 512 abuts directly against the bottom rear surface of the side rail member 506, as opposed to leaving a gap therebetween as shown in FIG. 1.

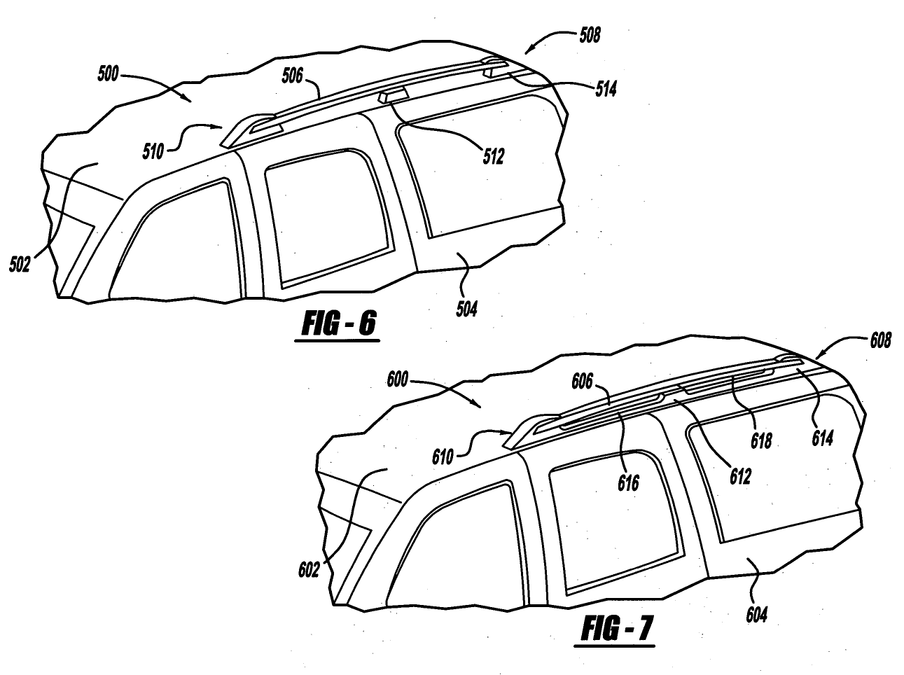

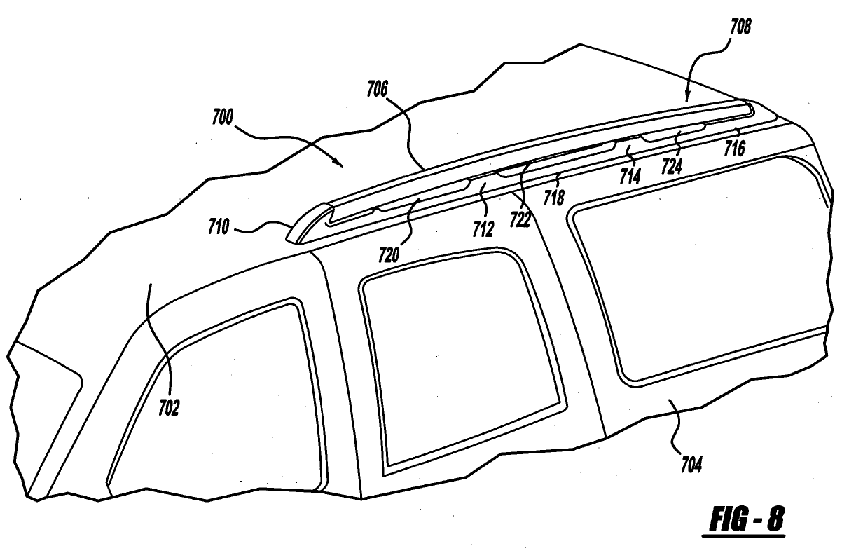

Referring to FIG. 7, there is shown a partial perspective view of a third alternative side rail system 600 fastened to the roof portion 602 of a vehicle 604, in accordance with a seventh embodiment of the present invention. The side rail system 600 primarily includes a side rail member 606 fastened to a support system 608, which can include a front support member 610, a center support member 612, and a rear support member 614. In this view, the front support member 610 envelopes an end portion of the side rail member 606, the rear support member 614 envelopes the other end portion of the side rail member 606, and the center support member 612 (extending from the front support member 610 and the rear support member 614) supports a bottom surface of the side rail member 606. The center support member 612 abuts directly against the bottom rear surface of the side rail member 606. However, two gaps 616, 618, respectively, are formed underneath the bottom front and rear surfaces of the side rail member 606, e.g., between the front support member 610 and the center support member 612 and between the rear support member 614 and the center support member 612.

Referring to FIG. 8, there is shown a partial perspective view of a fourth alternative side rail system 700 fastened to the roof portion 702 of a vehicle 704, in accordance with an eighth embodiment of the present invention. The side rail system 700 primarily includes a side rail member 706 fastened to a support system 708, which can include a front support member 710, a first center support member 712, a second center support member 714, and a rear support member 716. In this view, the front support member 710 envelopes an end portion of the side rail member 706, the rear support member 716 envelopes the other end portion of the side rail member 706, and the first and second center support member 712, 714, respectively, (the first center support 712 extending from the front support member 710 and the second center support member 714 extending from the rear support member 716) supports a bottom surface of the side rail member 706. The first and second center support members 712, 714, respectively, can be joined together by a connection member 718. The first and second center support members 712, 714, respectively, abut directly against the bottom rear surface of the side rail member 706. However, three gaps 720, 722, 724, respectively, are formed underneath the bottom front, center, and rear surfaces of the side rail member 706, e.g., between the front support member 710 and the first center support member 712, between the first and second center support members 712, 714, respectively, and between the rear support member 716 and the second center support member 714.

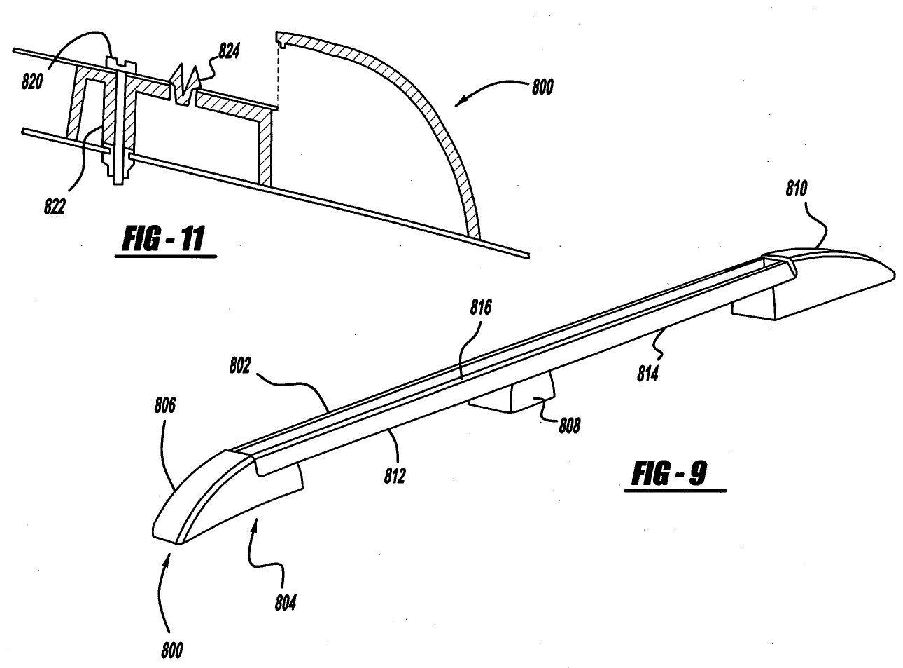

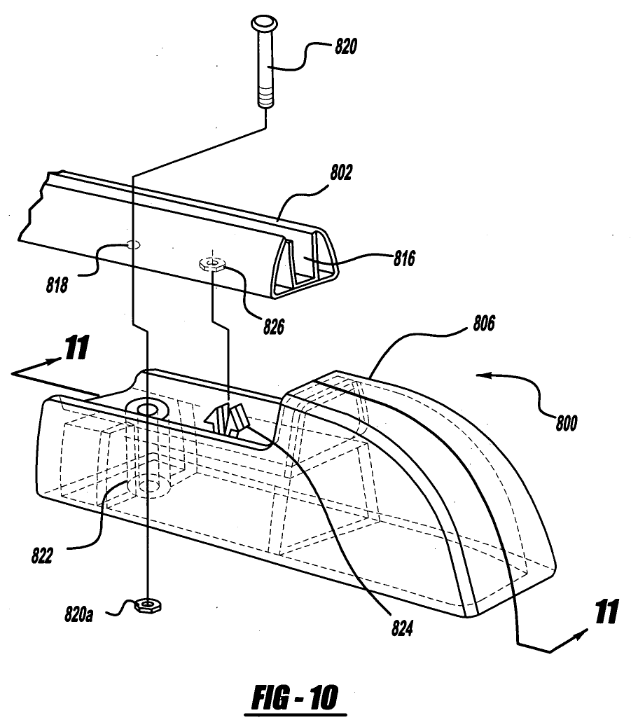

Referring to FIG. 9, there is shown a partial perspective view of a fifth alternative side rail system 800, in accordance with a ninth embodiment of the present invention. The side rail system 800 primarily includes a side rail member 802 fastened to a support system 804, which can include a front support member 806, a center support member 808, and a rear support member 810. In this view, the front support member 806 envelopes an end portion of the side rail member 802, the rear support member 810 envelopes the other end portion of the side rail member 802, and the center support member 808 supports a bottom surface of the side rail member 802. The center support member 808 abuts directly against the bottom rear surface of the side rail member 802. However, two gaps 812, 814, respectively, are formed underneath the bottom front and rear surfaces of the side rail member 802, e.g., between the front support member 806 and the center support member 808 and between the rear support member 810 and the center support member 808. In this view, a channel 816 is formed in a top surface of the side rail member 802, the purpose of which will be explained herein.

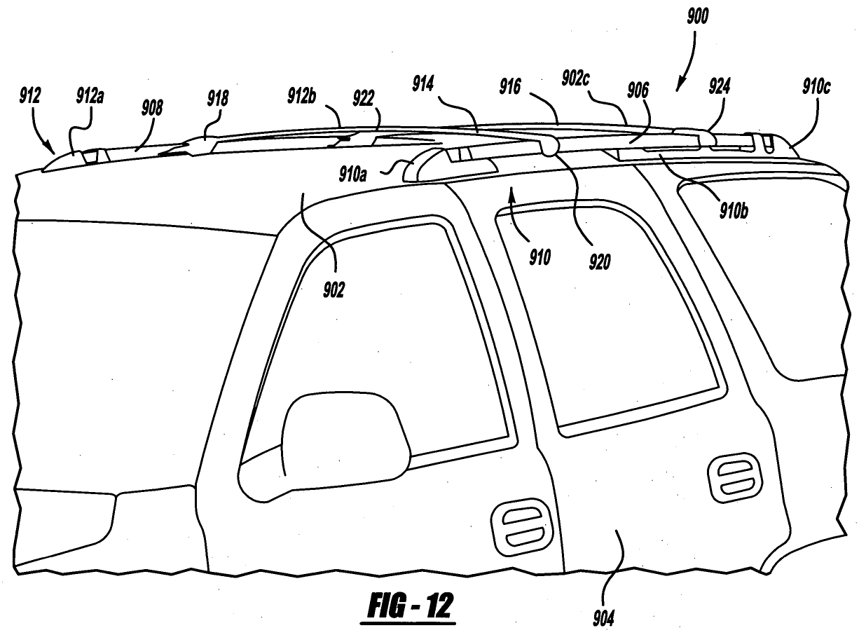

Referring to FIG. 10, there is shown a partial exploded view of the fifth alternative side rail system 800 depicted in FIG. 9, in accordance with a ninth embodiment of the present invention. In this view, a method for fastening the side rail member 802 to the front support member 806 (or a center and/or rear support member as well) will be described. As previously noted, the top surface of the side rail member 802 is provided with a channel 816 having at least one aperture 818 formed on a bottom surface thereof. The aperture 818 is sized so as to accommodate a fastening member 820 (e.g., a screw) that engages a fastening receptacle 822 (e.g., a threaded cylinder) provided on the front support member 806 (an optional threaded nut member 820a can be employed as well). By positioning the side rail member 802 on the front support member 806, such that the aperture 818 aligns with the fastening receptacle 822, the fastening member 820 can be inserted into the fastening receptacle 822 such that the side rail member 802 and the front support member 806 are fixedly secured to one another. Alternatively, a biasable member 824 can be provided on the front support member 806 that is operable to engage a second aperture 826 formed on a bottom surface of the channel 816. By positioning the side rail member 802 on the front support member 806, such that the second aperture 826 aligns with the biasable member 824, the biasable member 824 can be inserted into the second aperture 826 (e.g., in a snap fit arrangement) such that the side rail member 802 and the front support member 806 are fixedly secured to one another.

Referring to FIG. 11, there is shown a partial perspective view of the fifth alternative side rail system 800 along line 11-11 of FIG. 10, in accordance with a ninth embodiment of the present invention. In this view, the relative location of the fastening receptacle 822 and the biasable member 824 are clearly shown. The fastening member 820 is shown as being inserted in the fastening receptacle 822.

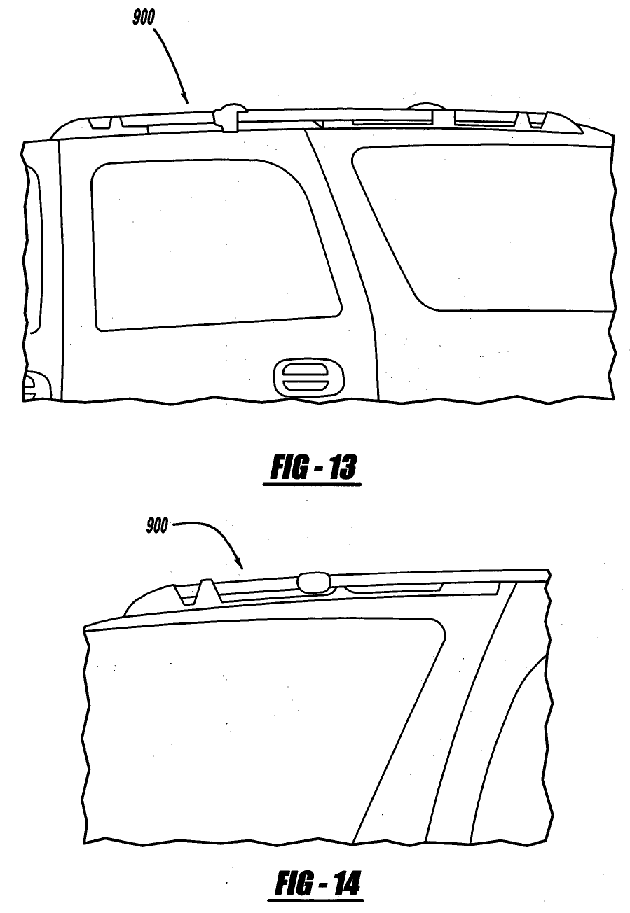

Referring to FIG. 12, there is shown a partial perspective view of a cargo rack system 900 fastened to the roof portion 902 of a vehicle 904, in accordance with a tenth embodiment of the present invention. In accordance with one aspect of the present invention, the cargo rack system 900 primarily includes at a pair of spaced and opposed side rail members 906, 908, respectively, each supported by support systems 910, 912, respectively (each consisting of front, center, and rear support members 910a, 912a, 910b, 912b, 910c, 912c, respectively), a pair of spaced and opposed cross rail members 914, 916, respectively, each attached to the side rail members by stanchion assemblies 918, 920, 922, 924, respectively.

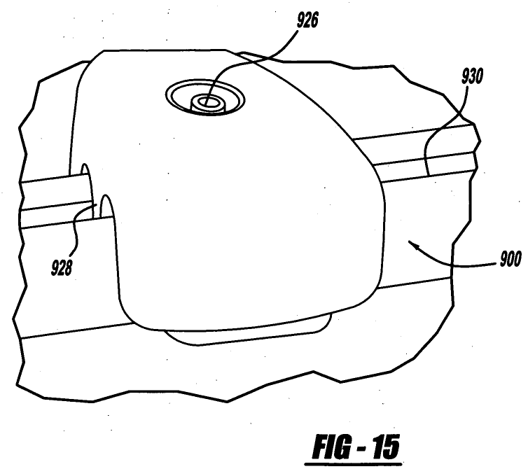

Referring to FIG. 13, there is shown a partial side elevational view of the cargo rack system 900 depicted in FIG. 12, in accordance with a tenth embodiment of the present invention.

Referring to FIG. 14, there is shown a partial rear elevational view of the cargo rack system 900 depicted in FIG. 12, in accordance with a tenth embodiment of the present invention.

Referring to FIG. 15, there is shown a partial perspective view of a stanchion assembly (either 918, 920, 922, 924) of the cargo rack system 900 depicted in FIG. 12, in accordance with a tenth embodiment of the present invention. In this view, the stanchion assembly fits partially or completely around one of the side rail members (while cooperating with a cross rail member) and is fastened to the side rail member by a fastening member 926 (e.g., a screw). Additionally, an optional member 928 can be provided on the underside of the stanchion assembly that can be received in the channel 930 formed in the side rail member, e.g., to provide stability to the connection.

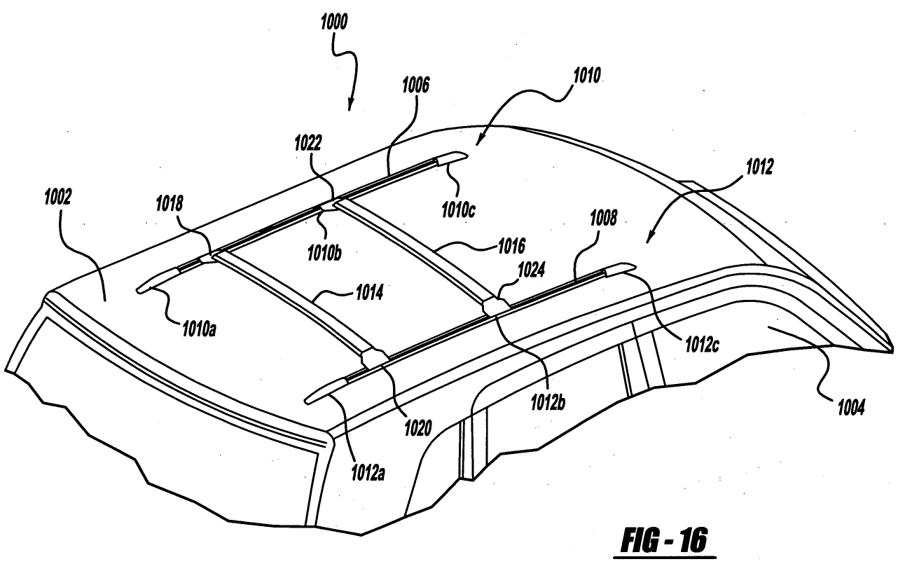

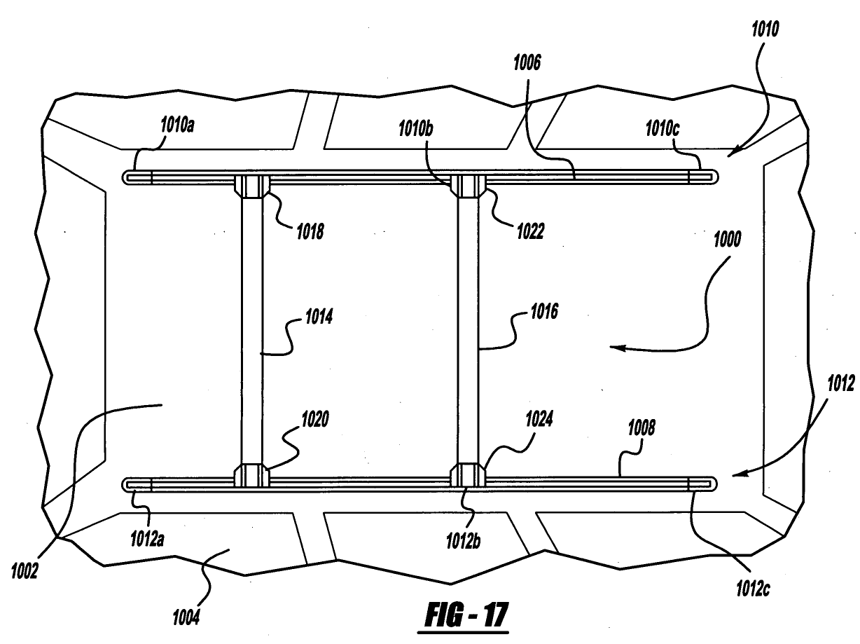

Referring to FIG. 16, there is shown a perspective view of an alternative cargo rack system 1000 fastened to the roof portion 1002 of a vehicle 1004, in accordance with an eleventh embodiment of the present invention. In accordance with one aspect of the present invention, the cargo rack system 1000 primarily includes at a pair of spaced and opposed side rail members 1006, 1008, respectively, each supported by support systems 1010, 1012, respectively (each consisting of front, center, and rear support members 1010a, 1012a, 1010b, 1012b, 1010c, 1012c, respectively), a pair of spaced and opposed cross rail members 1014, 1016, respectively, each attached to the side rail members by stanchion assemblies 1018, 1020, 1022, 1024, respectively.

Referring to FIG. 17, there is shown a plan view of the alternative cargo rack system 1000 depicted in FIG. 16, in accordance with an eleventh embodiment of the present invention.

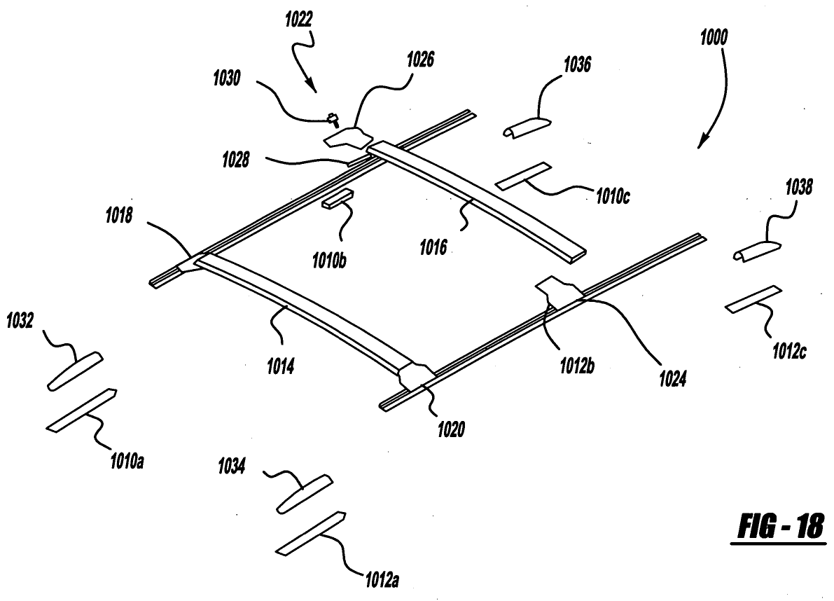

Referring to FIG. 18, there is shown an exploded view of the alternative cargo rack system 1000 depicted in FIG. 16, in accordance with an eleventh embodiment of the present invention. In this view, additional primary components of the stanchion assemblies are shown (e.g., in exploded view), including a stanchion member 1026, a clamp member 1028, and a fastening member 1030 (e.g., a thumbwheel). Additionally, the front and rear support members can be provided with optional cover members, 1032, 1034, 1036, 1038, respectively, e.g., to enhance the aesthetic appearance of respective support members.

Referring to FIG. 19, there is a sectional view of a cross rail member 1100, in accordance with a twelfth embodiment of the present invention. In this view, the cross rail member 1100 has a wing-like cross-sectional shape, wherein the leading edge 1102 gradually tapers towards the trailing edge 1104. However, it should be appreciated that the cross rail members of the present invention can be configured in any number of shapes.

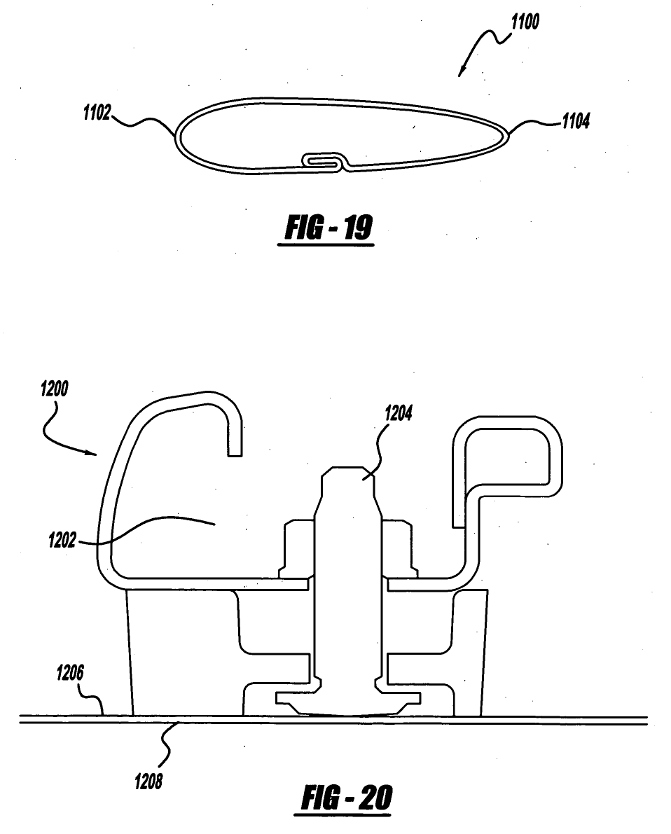

Referring to FIG. 20, there is shown a sectional view of a first alternative side rail member 1200, in accordance with a thirteenth embodiment of the present invention. In this view, a channel 1202 is clearly shown, wherein a fastening member 1204 (e.g., a bolt) connects the side rail member 1200 flush to the roof portion 1206 of the vehicle 1208.

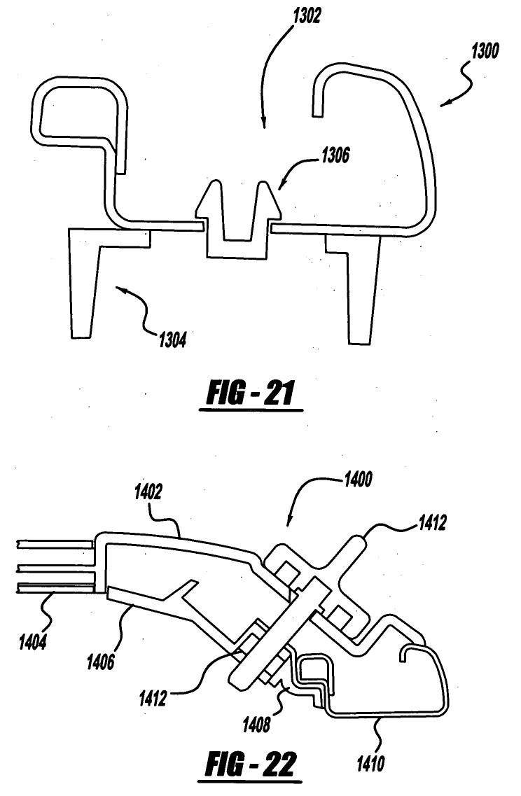

Referring to FIG. 21, there is shown a sectional view of a second alternative side rail member 1300, in accordance with a fourteenth embodiment of the present invention. In this view, a channel 1302 is clearly shown. However, the side rail member 1300 is raised up from the vehicle's roof portion by a support base 1034. An optionally connection member 1306 (e.g., a snap fit member) is shown that can receive a portion of a stanchion assembly (not shown), for example.

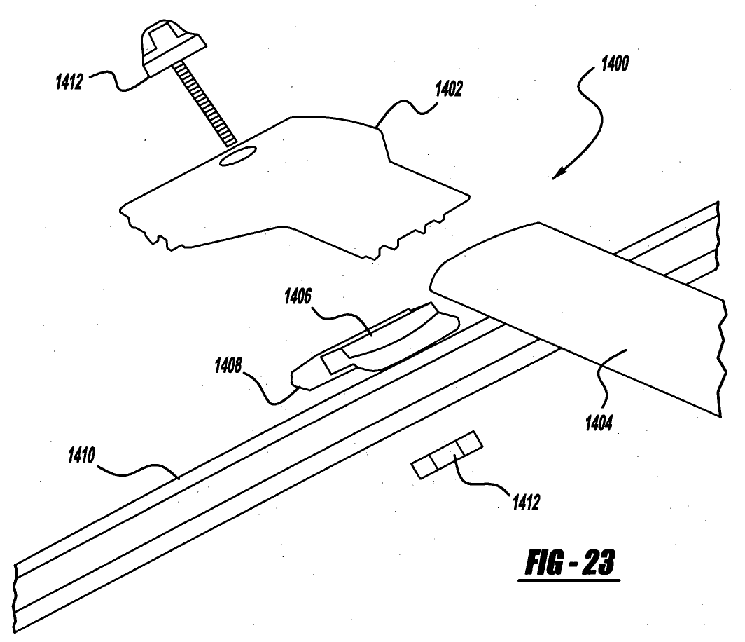

Referring to FIG. 22, there is shown a partial sectional view of a cross rail stanchion assembly 1400, in accordance with a fifteenth embodiment of the present invention. In accordance with one aspect of the present invention, the stanchion assembly 1400 includes a stanchion member 1402 (cooperating with a cross rail member 1404, e.g., in a telescoping/nested arrangement and/or a tongue/groove arrangement), a clamp member 1406, a pad member 1408 (e.g., abutting the clamp member 1406 and/or the side rail member 1410), a retaining nut 1412, and a fastening member 1414 (e.g., a thumbwheel) that is received through an aperture 1416 in the stanchion member 1402, and aperture 1418 formed in the clamp member 1406, and the retaining nut 1412. By way of a non-limiting example, as the fastening member 1414 is tightened by rotation through the retaining nut 1412, the fastening member 1414 is drawn taught against the exterior surface of the stanchion member 1402, thus drawings the clamp member 1406 and/or the pad member 1408 towards the stanchion member 1402. In this manner, the stanchion assembly 1400 is fastened securely to the side rail member 1410, and thus, the cross rail member 1404 to the side rail member 1410.

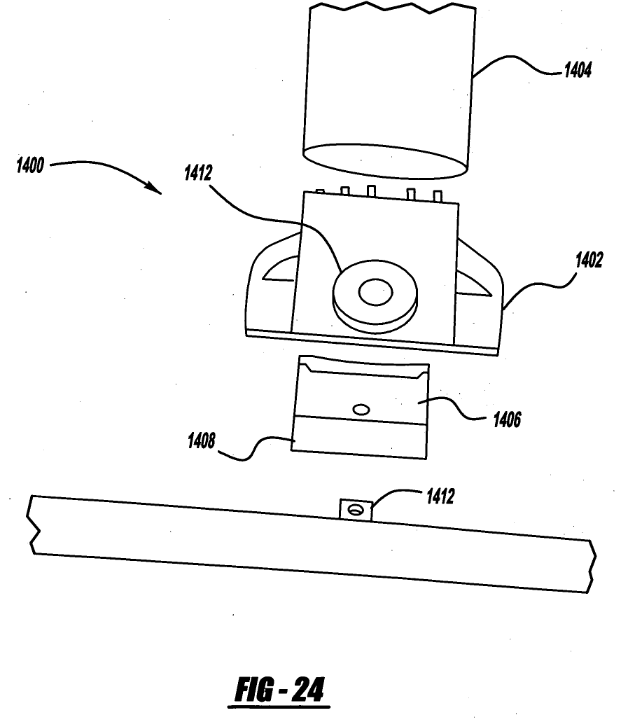

Referring to FIG. 23, there is shown a partial exploded view of the cross rail stanchion assembly 1400 depicted in FIG. 22, in accordance with a fifteenth embodiment of the present invention.

FIG. 24 is another partial exploded view of the cross rail stanchion assembly 1400 depicted in FIG. 22, in accordance with a fifteenth embodiment of the present invention.

Accordingly, the simplification and standardization of the cargo rack system designs of the present invention is based on current industry best practices. Those is, standardization and carryover of the rail sections and cross rail mechanism can be achieved through the present invention. As previously noted, the side rail sections can be designed so it can be used as either a raised or flush rack system. Additionally, the side rail sections can be designed to be an exposed rail for alternative finish applications, e.g., to change the overall look of the rack system by changing the finishes. Furthermore, the ability to easily remove the cross rails eliminate possible wind noise and improve vehicle fuel efficiency when the rails are not in use.

The simplicity of the overall design of the various systems and components thereof of the present invention is also apparent. For example, there is an infinite number of ways to adjust the cross rail assemblies along the length on the side rails. Additionally, improved system strength is achieved through simplicity of design and fewer components. Furthermore, attachment component styling can be changed from one vehicle to another to change the overall appearance of the cargo rack system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cargo rack system, comprising:
a support system fastened to a roof portion of a vehicle, the support system having a receptacle formed therein operable to receive a fastening member;
a side rail member having a bore formed in a surface thereof; and
a fastening member operable to fasten a portion of the side rail member to a portion of the support system, wherein the fastening member is substantially recessed into the receptacle when the side rail member is fastened to the support system so as to substantially obscure the fastening member from view.

2. The invention according to claim 1, further comprising:
a cross rail member; and
a stanchion assembly operable to fasten a portion of the cross rail member to the side rail member.

3. The invention according to claim 2, wherein an end portion of the cross rail member and an end portion of the stanchion assembly are in a nesting arrangement.

4. The invention according to claim 2, wherein the stanchion assembly includes a stanchion member, a clamp member, and a second fastening member, wherein the stanchion member and the clamp member are operable to envelope a portion of the side rail member, wherein the second fastening member fastens the second stanchion member and the clamp member together when the second stanchion member and the clamp member envelope a portion of the side rail member.

5. The invention according to claim 4, wherein the second fastening member is selected from the group consisting of a screw, thumbwheel, and combinations thereof.

6. The invention according to claim 4, wherein the stanchion assembly further comprises a pad member operably associated with the clamp member, and a nut member operably associated with the second fastening member.

7. The invention according to claim 1, wherein the support system includes at least one support member.

8. The invention according to claim 7, further comprising a cover member operably associated with the at least one support member.

9. A cargo rack system, comprising:
a support system fastened to a roof portion of a vehicle, the support system having a receptacle formed therein operable to receive a fastening member;
a side rail member;
a first fastening member operable to fasten a portion of the side rail member to a portion of the support system;
a cross rail member; and
a stanchion assembly operable to fasten a portion of the cross rail member to the side rail member.

10. The invention according to claim 9, wherein an end portion of the cross rail member and an end portion of the stanchion assembly are in a nesting arrangement.

11. The invention according to claim 9, wherein the stanchion assembly includes a stanchion member, a clamp member, and a second fastening member, wherein the stanchion member and the clamp member are operable to envelope a portion of the side rail member, wherein the second fastening member fastens the second stanchion member and the clamp member together when the second stanchion member and the clamp member envelope a portion of the side rail member.

12. The invention according to claim 11, wherein the second fastening member is selected from the group consisting of a screw, thumbwheel, and combinations thereof.

13. The invention according to claim 11, wherein the stanchion assembly further comprises a pad member operably associated with the clamp member, and a nut member operably associated with the second fastening member.

14. The invention according to claim 9, wherein the support system includes at least one support member.

15. The invention according to claim 14, further comprising a cover member operably associated with the at least one support member.

16. A cargo rack system, comprising:
a support system fastened to a roof portion of a vehicle, the support system having a receptacle formed therein operable to receive a fastening member;
a side rail member;
a first fastening member operable to fasten a portion of the side rail member to a portion of the support system;
a cross rail member; and
a stanchion assembly operable to fasten a portion of the cross rail member to the side rail member;
wherein the stanchion assembly includes a stanchion member, a clamp member, and a second fastening member, wherein the stanchion member and the clamp member are operable to envelope a portion of the side rail member, wherein the second fastening member fastens the second stanchion member and the clamp member together when the second stanchion member and the clamp member envelope a portion of the side rail member.

17. The invention according to claim 16, wherein an end portion of the cross rail member and an end portion of the stanchion assembly are in a nesting arrangement.

18. The invention according to claim 16, wherein the stanchion assembly further comprises a pad member operably associated with the clamp member, and a nut member operably associated with the second fastening member.

19. The invention according to claim 16, wherein the support system includes at least one support member

20. The invention according to claim 14, further comprising a cover member operably associated with the at least one support member.
